(19) United States
(12) Patent Application Publication
(10) Pub. No.: US 2017/0177016 A1
(43) Pub. Date: Jun. 22, 2017

(54) Smart Power Flow Solvers for Smart Power Grids

(71) Applicant: Bigwood Technology, Inc., Ithaca, NY (US)

(72) Inventors: Hsiao-Dong Chiang, Ithaca, NY (US); Bin Wang, Ithaca, NY (US); Tao Wang, Ithaca, NY (US); Ryuya Tanabe, Yokohama (JP)

(73) Assignees: Bigwood Technology, Inc., Ithaca, NY (US); Tokyo Electric Power Company, Incorporated, Tokyo (JP)

(21) Appl. No.: 14/976,293

(22) Filed: Dec. 21, 2015

(51) Int. Cl. G05F 1/66; G05B 11/01; G05F 1/12

(52) U.S. Cl. CPC G05F 1/66; G05F 1/12; G05B 11/011

(57) ABSTRACT

A smart power flow solver integrates the TRUST-TECH based power flow methodology into a power flow solution. A first solver is applied to a power flow problem of a power system. If results of the first solver diverge, A Trust-Tech based solver is applied to the power flow problem by: transforming the power flow problem to an unconstrained global optimization problem; iteratively solving a dynamical system associated with the unconstrained global optimization problem; and determining whether a solution exists for the power flow problem based on whether the iteratively solving of the dynamical system converges. If a solution exists for the power flow problem, a second solver is then applied to the power flow problem. An operating state of the power system is generated based on results of the second solver to enable proper operation of the power system.

### TECHNICAL FIELD

Embodiments of the invention pertain to the field of analyzing power networks. More particularly, embodiments of the invention pertain to methods and systems for solving power flow problems of power networks.

### BACKGROUND

Power flow study is a routine task in power system analysis, planning and study. At present, power system planners may encounter problems when building planning study base cases from a large interconnected system. For instance, the planners in a large eastern utility insert a more detailed representation of its service territory into a standard model defined by the multiregional modeling working group (MMWG). After this modification of the base case, existing power flow tools often fail to solve the power flow case. In these instances, it is very difficult and time-consuming to produce a solution for the new base case. Indeed, power system planners spend a significant amount of time in running power flow studies for both purposes of power system planning and design. The typical problem that power system planners encounter is the problem of power flow divergence.

The introduction of new power system devices and renewable energies can further aggravate the problem of power flow divergence. It is well known that the Newton-Raphson (NR) method, widely used in power industry in the power flow study, has difficulties in dealing with nonlinear devices such as Flexible Alternating Current Transmission System (FACT) devices, high R/X transmission lines and heavy loading conditions. It is expected that NR method and its variants such as the fast-decoupled power flow method will encounter the power flow divergence problem when applied to smart power grids, which need to transfer a variety of power flow patterns due to renewable energies and contain new nonlinear, smart devices.

The conventional options to overcome the power flow divergence available to planners are quite limited. These options often include (1) trying a different initial guess for the power flow study, or (2) trying different power flow solvers such as variants of Newton method or Quasi-Newton method. Unfortunately, these conventional options may lead to unsuccessful attempts. Option (1) is rather tedious and has a low success rate while option (2) may also not have high success rates. To speed up the power flow studies for on-line applications and to increase the productivity for power system planners, it is hence necessary to develop more robust and intelligent tools for power flow studies.

Another huge gap is the issue of the existence of a power flow solution. This issue is especially important for power system planning study, while it is not so important for current power system operation studies. However, this issue may become significant for power system operation studies with increasing penetration of renewable energies. For a power system planning study, it is possible that power flow solutions of a planning study do not exist for several reasons. It is hence essential to provide a tool that can reliably identify the existence or non-existence of a power flow solution. If a power flow solution exists, then the intelligent tool will identify the existence of the solution and provide a good initial guess for the solution.

Generally, power flow convergence is obtained in a reasonable number of iterations from a flat start initial point for “normal” power networks. However, divergence of power flow studies can occur and the users/analysts are faced with the following dilemma:

Situation EN: a power flow solution does exist but the numerical method has failed to converge to it from the given starting point, or

Situation NE: no power flow solution exists with the specified network topology and loading condition.

From the viewpoint of developing power flow methods, the Situation EN can be further classified into the following numerical problems:

Initial Guess Problem: The convergence region of a power flow solution is such that either the ‘flat start’ point does not lie inside its convergence region or an appropriate point inside the convergence region is hard to obtain, perhaps due to the small-size convergence region. This type of numerical problem can occur when the power flow solution is “abnormal” due to extreme power network conditions.

Ill-Conditioned Problem: The Jacobian matrices near the power flow solution are ill-conditioned, making the NR method or its variants diverge. The ill-conditioned numerical problem occurs (i) when there are high R/X ratios of transmission lines, (ii) when connecting very low or high impedance lines to a bus, (iii) when the power grid is heavily loaded and close to its steady-state stability limit.

Undesired power flow solutions: Typically, the bifurcation points of power flow equations are either saddle-node bifurcation points (SNB) or structure-induced bifurcation points (SIB). The Jacobian matrix at the SNB is singular, making the Newton method or its variants diverge when finding the power flow solution at the SNB. On the other hand, the Jacobian matrix at the SIB is nonsingular and the Newton method typically computes the SIB without convergence problems.

To overcome the above three numerical problems, many numerical methods have been proposed and they can be classified into the following categories.

Optimal-multiplier-based methods: This class of methods started in the late 1970s. The key Newton method is applied using an optimal multiplier to modify the iterations. This is achieved by minimizing the sum of squares of the mismatches of the defining functions, which are expressed in terms of the optimal multiplier and the latest updates.

Optimal step-sized methods: The idea of the optimal step-sized methods is to determine the optimal step-size of the Newton correction direction, instead of simply a unity step-size, so that a defined function is minimized. Several optimal step-sized methods have been proposed in the literature. Comparison study of three optimal step-sized methods has been conducted in literature.

Continuation-based power flow methods: Continuation power flow (CPFLOW) is a powerful tool for simulating power system steady-state stationary behaviors with respect to a given power injection variation scenario. The continuation power flow methods resolve the numerical difficulty arising from ill-conditioning conditions. CPFLOW is effective to overcome the ill-conditioned problems.

Meta-heuristics-based methods: A constrained Genetic Algorithm (GA) power flow method was proposed in literature. The objective function to be minimized is the total of the squared power mismatch and voltage mismatch. The nodal voltages are updated using constraint satisfaction techniques during the GA power flow solution process. Recent meta-heuristic-based methods include the chaotic particle swarm optimization based power flow method. This method attempts to serve as a general-purpose power flow solver that is robust under ill-conditioned power networks when conventional Newton methods fail. The meta-heuristic-based power flow methods can achieve a satisfactory convergence property and the ability to determine multiple power flow solutions. However, this class of methods still suffers from the following: i) its computational speed is slow, compared to the Newton power flow method; ii) it cannot obtain a precise power flow solution; iii) it is impossible to determine whether or not a power flow solution exists when the method cannot find a power flow solution; and iv) it cannot deal with the generator reactive power limits.

Continuous Newton's method: This method basically converts the set of power flow equations into a set of ordinary differential equations and applies numerical integration methods to compute the power flow solutions. This method can be effective in overcoming the ill-conditioned problem but it can be ineffective in dealing with the initial guess problem and the bifurcation point problem. The continuous Newton method for power flow solutions also suffers from the above four difficulties (i)-(iv) while the continuation-based power flow solvers suffer only from the difficulties (i) and (iii).

Homotopy-based power flow method: Unlike the Newton method and its variants, which rely on information about the function at particular points in its domain of definition, homotopy methods are global methods by utilizing a genuine global property of the mapping that is preserved under a homotopy-topological degree. A variety of homotopy methods have been developed not only to overcome the local convergence nature of many iterative methods including the Newton method but also to compute multiple solutions. Homotopy methods are also useful for solving difficult problems for which a good starting point close to a desired solution is hard to obtain. In many cases, homotopy methods have succeeded in finding solutions where Newton's method failed. Homotopy methods are capable of achieving global convergence for solving systems of nonlinear algebraic equations. However, homotopy-based methods still suffer from the following problems: i) homotopy-based methods may still diverge, and ii) homotopy-based methods may still be slow.

A number of holomorphic embedding power flow (HEPF) methods have been developed in the past; e.g. U.S. Pat. No. 7,519,506 B2 and U.S. Pat. No. 7,979,239 B2, both of which issued to Trias. HEPF adopts a homotopy-continuation methodology when constructing the complex embedding systems, and performs numerical approximation by taking advantage of holomorphic (or analytic) properties of complex solution functions and using algebraic approximants (e.g. Pade approximant) to achieve better convergence rate and larger convergence region. It is claimed by Trias that the method can always converge to the correct power flow solution. This claim is drawn based on the assumption that correct power flow solution is always close to a “flat start” in which all voltage angles are set to zero and all voltage magnitudes are set to 1.0 per unit. However, this assumption might not be valid, especially for nowadays aging and heavily loaded power grids with increasing penetration of renewable energy, whose operating condition might change rapidly and be far away from “flat” states. It is also claimed by Trias that the method can unambiguously signal the condition of nonexistence of power flow solution, which is realized as the divergence of the recursively computed analytic continuation parameters. However, divergence of the recursive procedure for computing analytic continuation parameters cannot necessarily be translated to nonexistence of power flow solutions; neither can an index be designed based on the diverged recursion to indicate “how far” a system existing no power flow solutions is away from having a power flow solution. Besides the two claimed aspects, in the meantime, the method also suffers from its inability to handle limits imposed on reactive power generations.

In summary, despite the significant progress made in the power flow technologies, existing methods still cannot determine the cause of power flow divergence regardless of whether it is due to Situation EN or due to Situation NE. The current not-so-smart grids already have power flow divergence problems, so it is conceivable that smart grids in the near future will make this problem more challenging. It is hence desirable to develop a smart power flow methodology for large power grids to overcome the dilemma encountered by existing methods.

### SUMMARY

According to one embodiment of the invention, a method is provided for analyzing power flow of a power system. The method comprises: receiving input which describes power flow characteristics of the power system as a power flow problem; applying a first power flow solver to the power flow problem; in response to a first determination that results of the first power flow solver diverge, applying a Trust-Tech based solver to the power flow problem. Applying the Trust-Tech based solver further comprises: transforming the power flow problem to an unconstrained global optimization problem; iteratively solving a dynamical system associated with the unconstrained global optimization problem; and determining whether a solution exists for the power flow problem based on whether the iteratively solving of the dynamical system converges. The method further comprises: applying a second power flow solver to the power flow problem in response to a second determination that the solution exists for the power flow problem; and outputting an operating state of the power system based on results of the second power flow solver to thereby enable proper operation of the power system.

In another embodiment, a system is provided for analyzing power flow of a power system. The system comprises: one or more processors; and a memory, the memory containing instructions executable by the one or more processors. The one or more processors are operable to: receive input which describes power flow characteristics of the power system as a power flow problem; apply a first power flow solver to the power flow problem; in response to a first determination that results of the first power flow solver diverge, apply a Trust-Tech based solver to the power flow problem. Applying the Trust-Tech based solver further comprises: transform the power flow problem to an unconstrained global optimization problem; iteratively solve a dynamical system associated with the unconstrained global optimization problem; and determine whether a solution exists for the power flow problem based on whether the iteratively solving of the dynamical system converges. The one or more processors are further operable to: apply a second power flow solver to the power flow problem in response to a second determination that the solution exists for the power flow problem; and output an operating state of the power system based on results of the second power flow solver to thereby enable proper operation of the power system.

In yet another embodiment, a non-transitory computer readable storage medium is provided. The non-transitory computer readable storage medium includes instructions that, when executed by a computing system, cause the computing system to perform the afore-mentioned method for analyzing power flow of a power system.

### BRIEF DESCRIPTION OF THE DRAWINGS

FIGS. 1A, 1B and 1C illustrate the relationships between the existence subspace, the non-existence subspace, the feasible subspace, and the infeasible subspace.

FIGS. 2A, 2B, 2C and 2D illustrate example points in the existence and non-existence regions in the power injection space, and corresponding constant contours in the state space.

FIG. 3 illustrates a best possible solution when there is no power flow solution for an example 2-bus system.

FIG. 4 illustrates a flowchart of a TRUST-TECH based smart power flow method according to one embodiment.

FIG. 5 illustrates a flowchart of an HEPF method according to one embodiment.

FIG. 6 illustrates a flowchart of an enhanced HEPF method with PV-PQ bus switch capabilities according to one embodiment.

FIG. 7 illustrates a flowchart of a method of a smart power flow solver according to one embodiment.

FIG. 8 illustrates a flowchart of a method of a smart power flow solver according to another embodiment.

FIG. 9 is a block diagram illustrating an example of a system for a smart power flow solver according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a system and a method of smart power flow solvers that integrate the TRUST-TECH based power flow methodology and an enhanced HEPF method. These smart power flow solvers aim to meet aforesaid critical needs of a smart power flow methodology, which is designed to guide effective power flow solvers to overcome the dilemma. Compared with existing power flow methods, the smart power flow solvers disclosed herein possess the following distinct features.

1) Global convergence: It is notoriously known that the convergence region for Newton's power flow methods is fractal. In contrast, the smart power flow solvers developed herein are globally convergent because of the complete stability of the tailored dynamical system of TRUST-TECH methodology; in other words, the convergence region of the smart power flow solvers spans the whole search space, instead of a fractal subspace.

2) Detection of existence or nonexistence: Existing power flow methods not only are prune to divergence caused by bad initial points, because of the fractal convergence region, but also lack the capability to determine whether there exist power flow solutions or not. Indeed, divergence of existing power flow methods cannot necessary be translated to nonexistence of power flow solutions. In contrast, the smart power flow solvers disclosed herein are able to detect whether there exist power flow solutions or not, which is realized with TRUST-TECH methodology and transformed to the task of detecting whether there exist certain stable equilibrium manifolds (SEMs) of a tailored nonlinear dynamical system. In the meantime, an index is readily available to indicate “how far” a system existing no power flow solutions is away from having a power flow solution.

3) Non-divergence: Existing power flow methods of the conventional formulation, such as the Newton's methods, are prone to divergence. The smart power flow solvers are non-divergent, due to the global convergence of the TRUST-TECH methodology and the non-divergence of the enhanced HEPF method.

4) Practical operating points: For the conventional formulation, there exist two power flow solutions before the saddle node bifurcation point, only one of which reflects the practical operating conditions of the power network. In contrast, the solutions obtained by the smart power flow solvers, which use a non-conventional formulation, are guaranteed to be practical operating points.

5) Implicit PV-PQ switch: In power flow computation, if the voltage magnitude of a bus can be regulated by the automatic voltage regulator of generator or the continuously-switchable shunt, its type may be switched between PV and PQ. Generally speaking, the type of a bus is PV, which means the real power injection and voltage magnitude of a bus are fixed while its reactive power injection and voltage phase angle are free. When its reactive power injection reached its upper or lower limit, the type of this bus becomes PQ, which means that the real and reactive power injections are fixed while the voltage phase angle and magnitude are free. If limits on reactive power generations are considered, existing power flow solvers need to explicitly perform PV-PQ bus switching whenever a reactive generation limit is reached. Such an explicit switching of PV-PQ buses will result in a change to the power flow problem structure, which may in turn result in a special type of divergence called “identification divergence.” In contrast, the smart power flow solvers avoid such divergence by implementing an implicit PV-PQ switching scheme in a constrained power flow formulation, which is then solved with the TRUST-TECH methodology and efficient numerical methods.

6) Adaptive convergence criteria for algebraic approximants: With the smart power flow solvers, adaptive convergence criteria are provided in the enhanced holomorphic embedding power flow method to automatically stop the algebraic approximation without manual intervention.

In the following, embodiments of smart power flow solvers are described. Before describing the smart power flow methods, related concepts are first introduced.

Existence and Feasibility of Power Flow Solutions. Power flow equations for an n-bus power system can be expressed as

S=F(x), (1)

where without loss of generality

x=(e₁,e₂, . . . ,eₙ₋₁,ƒ₁,ƒ₂, . . . ,ƒₙ₋₁)

S=(P₁,P₂, . . . ,Pₙ₋₁,Q₁,Q₂, . . . ,Qₙ₋₁),Vᵢ=eᵢ+jfᵢ (2)

In this expression, eᵢ and ƒᵢ are the real and imagery parts of the voltage Vᵢ of the i-th bus in the rectangular representation, S is the vector of power injections, with Pᵢ and Qᵢ are the real and reactive power injections at the i-th bus, respectively. F(x) is the set of power flow equations

F(x)=[Fₚ₁(x),Fₚ₂(x), . . . ,Fₚₙ₋₁(x),F_{q1}(x),F_{q2}(x), . . . ,F_{qn-1}(x)], (3)

with

Fₚᵢ(x)=Σⱼ₌₁ⁿ[eᵢ(eⱼGᵢⱼ−ƒⱼBᵢⱼ)+ƒᵢ(ƒⱼGᵢⱼ+eⱼBᵢⱼ)]

F_{qi}(x)=Σⱼ₌₁ⁿ[ƒᵢ(eⱼGᵢⱼ−ƒⱼBᵢⱼ)−eⱼ(ƒⱼGᵢⱼ+eⱼBᵢⱼ)]′ (4)

where, Gᵢⱼ and Bᵢⱼ are the conductance part and the susceptance part, respectively, of the (i, j)-th item of the system admittance matrix (i.e., the Y matrix).

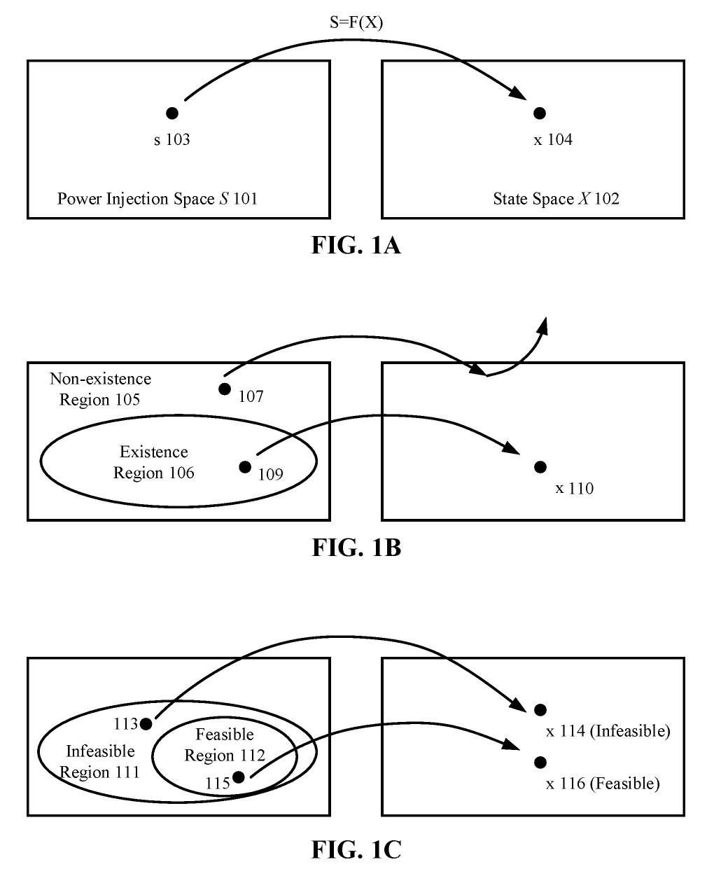

FIGS. 1A-1C illustrate a complex relationship between the power injection space S and the state space X described by the power flow equation (1), according to one embodiment. Referring to FIG. 1A, the power flow equation (1) maps a point s 103 in the power injection space S 101 to a point x 104 in the state space X 102. Depending on the location of the power injection space, the corresponding power flow solution may or may not exist. Referring to FIG. 1B, the power injection space S 101 can be divided into the existence subspace 106 and non-existence subspace 105. For each point 109 in the existence region 106, there is at least one point 101 in the state space 102 that satisfies the power flow equation (1); for any point 107 in the non-existence region 105, there is no point in the state space 102 that satisfies the power flow equation (1). Referring to FIG. 1C, the existence subspace 106 can be further divided into the feasible subspace 112 (when the corresponding power flow solution is feasible) and infeasible subspace 111 (when the corresponding power flow solution is infeasible). For each point 115 in the feasible region 112, the point 116 in the state space that satisfies the power flow equation (1) is called a feasible solution; for each point 113 in the infeasible region 111, the point 114 in the state space that does not satisfy the power flow equation (1) is called an infeasible point. One challenge arises accordingly, that is, how to characterize the following subspaces: i) the existence subspace 106, ii) the non-existence subspace 105, iii) the feasible subspace 112, and iv) the infeasible subspace 111.

The non-existence of power flow solution problem can be explained via a simple two-bus example. In this example, bus 1 is a slack bus with constant voltage of 1.0+j0.0 per unit (p.u.), and bus 2 is a load bus with constant P-Q. The transmission line is lossless with reactance of 0.1 p.u. and no shunt charging. The power flow equation for this simple two-bus system can be represented as follows:

P=−fb₁₂

Q=eb₁₂+ƒ²b₂₂+e²b₂₂′ (5)

with V₂=e+jf being the phasor voltage at bus 2 and P+jQ being the load demand. Let b₁₂=10=b₂₂, the elements of the network bus admittance matrix. The Jacobian is

$$J = [ \begin{matrix}0 & - {b}_{12} \\ {b}_{12} + 2 {eb}_{22} & 2 {fb}_{22}\end{matrix} ] . \qquad ( 6 )$$

The bifurcation boundary for this simple two-bus is characterized by

det(J)=0=b₁₂(b₁₂+2eb₂₂). (7)

Here, with b₁₂=b₂₂, the solution is e=+0.5. By substituting this power flow solution into the power flow equation (5), the bifurcation boundary Σ can be calculated to be the set of all points satisfying the following equation

$$\frac{{p}^{2}}{{b}_{12}} + Q - \frac{1}{4} {b}_{12} = 0. \qquad ( 8 )$$

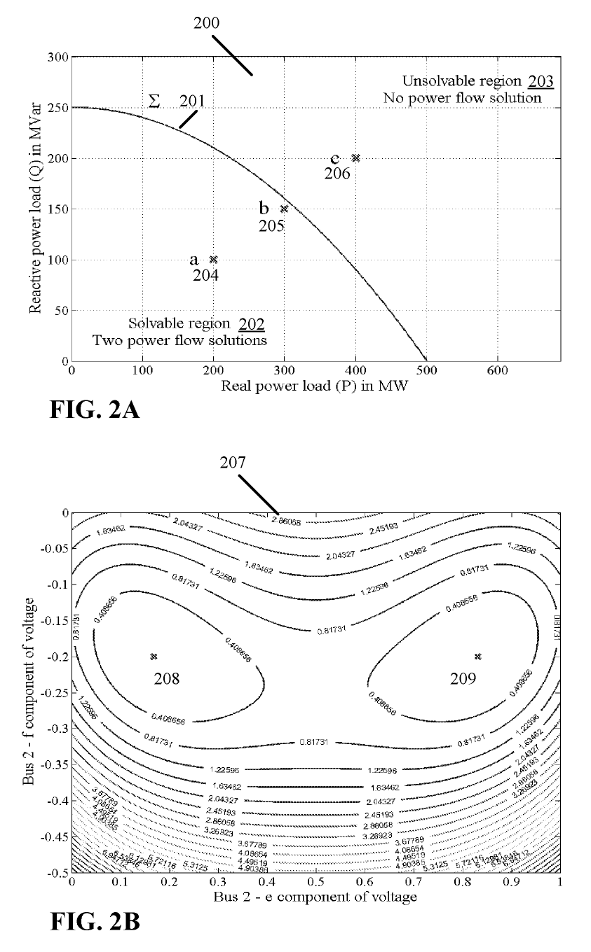

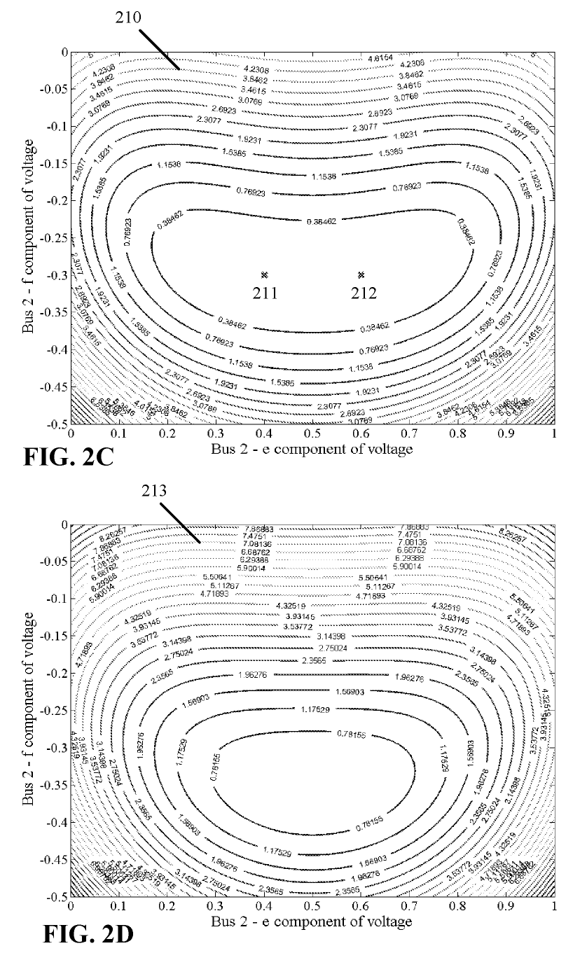

FIGS. 2A-2D illustrate an example of the bifurcation boundary, the existence region, and the non-existence region according to one embodiment. Referring to FIG. 2A, the power injection space 200 is divided into the existence region (also referred to as the solvable region 202) and the non-existence region (also referred to as the unsolvable region 203) by the bifurcation boundary Σ 201. The bifurcation boundary Σ 201 is included as part of the solvable region 202. For each point (case a and case b) lying inside the solvable region 202 (not on the bifurcation boundary Σ 201), there are two power flow solutions in the state space that satisfy the power flow equation (1); while for each point lying on the bifurcation boundary Σ 201, there is only one solution in the state space that satisfies the power flow equation (1); while for each point (case c) lying inside the unsolvable region 203, there is no power flow solution in the state space that satisfies the power flow equation (1).

When there is no power flow solution, one useful measure to quantify the distance to the bifurcation boundary is the distance (for example, the Euclidean norm) in the S-space 200 (i.e. the power injection space) between the current point and closest point on Σ 201. The following cost function is used to quantify such distance:

C(x)=½(F(x)−S)^{T}(F(x)−S). (9)

Thus C(x) is greater than or equal to zero for all x and is only equal to zero at power flow solutions.

For the 2-bus system, the cost function becomes

C(x)=½[(−fb₁₂−P)²+(eb₁₂+ƒ²b₂₂+e²b₂₂−Q)²]. (10)

The constant contours of the cost function corresponding to the above three cases are plotted in FIGS. 2B-2D. Referring to FIG. 2B, the contour map 207 corresponding to case a, there are two power flow solutions 208 and 209 in the state space corresponding to the point a 204 in the existence region 202 with P+jQ=200 MW+j100 MVar. Referring to FIG. 2C, the contour map 210 corresponding to case b, there are also two power flow solutions 211 and 212 in the state space corresponding to the point b 205 in the existence region 202 with P+jQ=300 MW+j150 MVar. Referring to FIG. 2D, the contour map 213 corresponding to case c, there is no power flow solution corresponding to the point c 206 with P+jQ=400 MW+j200 MVar in the non-existence region 203 outside the bifurcation boundary Σ 201.

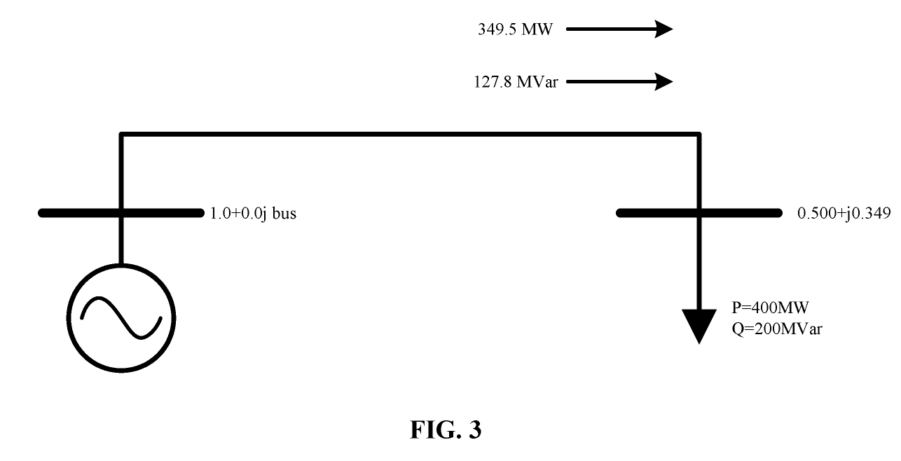

For the cases where there is no power flow solution, let x^{m} be defined as the value of x corresponding to the minimum of the cost function C(x); thus x^{m} may be used to represent the “best possible” solution to the power flow equations. The “best possible” solution when there is no power flow solution corresponding to a load of 400 MW and 200 MVar is shown in FIG. 3.

Restoring Power Flow Solutions. For the cases where there is no power flow solution, the goal of a desired algorithm is to determine x^{m}. Define S^{m}=F(x^{m}) to be the point in the parameter space corresponding to x^{m}. Information about x^{m} and S^{m} can then be utilized to provide the user with a measure of the insolvability of the solution. The ultimate goal is to provide guidance as to which parameters to vary to restore a power flow solution. This measure can be developed from the following observations about x^{m}:

Observation 1: The Jacobian of the power flow equation at x^{m}, J(x^{m}), is singular. This can be seen by recalling the necessary condition for x^{m} to be a local minimum point, which is

∇C(x^{m})=[F(x^{m})−S]^{T}J(x^{m})=0. (11)

Since [F(x^{m})−S]≠0, this implies that J(x^{m}) is singular.

Observation 2: The closest point (using a Euclidean norm) on the boundary Σ to S is S^{m}=F(x^{m}). That S^{m} is an element of Σ follows from the first observation. That S^{m} is the closest point follows from the definition of x^{m} as minimizing (9), which is equivalent to minimizing the Euclidean norm.

Observation 3: The “optimal” direction to move in the parameter space to return to solvability is then given by [S−S^{m}]. Intuitively this can be seen by noting that at the point x^{m}, [S−S^{m}] are just the real/reactive mismatches at each bus. Not surprisingly, the system can be moved back to the solvable region boundary if the power injections are changed so all bus mismatches are set to zero. More formally, this can be seen by noting that [S−S^{m}] is the left eigenvector, noted as w^{m}, of the zero eigenvalue of J(x^{m}). It can be shown that w^{m} is parallel to the normal vector to Σ at S^{m}. Since S is an element of the normal ray emanating from S^{m}, the “optimal” direction to move back to E is in the opposite direction to the normal, that is [S−S^{m}].

The distance between the best possible solution to the power flow equations and S, given by

d(s)=\sqrt{[S^{m}−S]^{T}[S^{m}−S]}, (12)

can then be used at a measure of the insolvability of a power flow solution, with the optimal direction to return to solvability given by [S−S^{m}]. For example, in the FIG. 2D case, where the load is P+jQ=400 MV+j200 MVar, the best possible solution, and value of ƒ(x^{m}) are shown in FIG. 3. At this solution the mismatches at the load bus are 50.5 MW and 72.2 MVar. The value of the per unit (100 MVA base) distance from equation (12) is then 0.88. Thus the minimum load variation to just achieve solvability would be to decrease the real load by 50.5 MV and the reactive load by 72.7 MVar. The Jacobian is computed to verify that this is indeed parallel to the left eigenvector:

$$J ( {x}^{m} ) = [ \begin{matrix}0 & - 10.00 \\ 0 & 6.98\end{matrix} ] . \qquad ( 13 )$$

The left eigenvector w^{m}=[0.572, 0.820] is easily verified as being nearly parallel to the mismatch vector.

Constrained Power Flow Formulation. Power flow study solves the power flow equation (1), which can also be represented as the following set of algebraic AC power flow equations:

F(x)=0, (14)

along with necessary physical constraints. Equivalent to the rectangular representation, the set of state variables can also be represented in the polar coordinate system as x=(V, θ). The set of algebra equations (14) representing the balance between the injected energy and the consumed energy in the power system thus are

$$F ( x ) = ( \begin{matrix}P ( x ) + {P}_{d} ( x ) - {P}_{ℊ} ( x ) \\ Q ( x ) + {Q}_{d} ( x ) - {Q}_{ℊ} ( x )\end{matrix} ) . \qquad ( 15 )$$

To avoid redundant equivalent solutions, additional constraints are considered for power flow calculation. One such constraint is that the voltage magnitude and phase angle on the slack generator bus need to be fixed; accordingly, the equality constraints on the slack generator bus can be represented as

$$H ( x ) = ( \begin{matrix}{V}_{s} - {V}_{0} \\ {θ}_{s}\end{matrix} ) = 0 , \qquad ( 16 )$$

where, Vₛ is the voltage magnitude of the slack generator bus, V₀ is the initial value of the voltage magnitude, and θₛ is the phase angle of the voltage of the slack generator bus.

Furthermore, before the reactive power limits of generators are reached, the voltage magnitude of generator buses remain constant, which is a PV bus; while after the reactive power limits are reached, the reactive powers of generators remain constants (at its lower or upper limit) and at the same time, the voltage magnitudes become state variables and the bus becomes a PQ bus. Existing (i.e. prior art) power flow solvers explicitly perform the PV-PQ bus switching whenever a reactive generation limit is reached. Such an explicit switching of PV-PQ buses results in a change to the power flow problem structure, which may in turn result in a special type of divergence called “identification divergence.” In contrast, the smart power flow solvers avoid such divergence by incorporating additional constraints in the constrained power flow formulation. More specifically, constraints on generator buses constitute two parts. First, both states before and after the Q-limit is reached are captured by the following set of complementary equality constraints

C(x)=(Q_{g}−Q_{g}^{max})·(V_{g}−V_{g0})=0, (17)

where the above expression is an inner product; i.e. it is the element-by-element product for all generator buses (except the slack generator bus).

Finally, there are also physical limitations imposed on reactive power of non-slack generator buses, that is, Q_{g}≦Q_{g}^{max}. Therefore, the constrained power flow problem can be formulated as the following constraint satisfaction problem with both equalities and inequalities:

P(x)+P_{d}(x)=P_{g}(x)

Q(x)+Q_{d}(x)=Q_{g}(x)

Vₛ=V₀

θₛ=0

(V_{g}−V_{g0})·(Q_{g}−Q_{g}^{max})₀

Q_{g}≦Q_{g}^{max} (18)

The last inequality constraints of reactive generation limits in (18) can be transformed into equality constraints as follows

E(x)=(Q_{g}−Q_{g}^{max})·δ_{ε}(Q_{g}−Q_{g}^{max}) (19)

where δ_{ε}(·) is the step function defined as:

$${δ}_{∈} ( x ) = \{ \begin{matrix}0 , x < ∈ \\ 1 , x \geq ∈\end{matrix} . \qquad ( 20 )$$

This is the active-set concept. ε is generally chosen to be a small negative value (to e.g. −1e−10), instead of exact 0, to accommodate those points close to the constraint boundary and also to compensate the imperfect precision of digital computers that implement the power flow solvers. This will enhance the robustness of the solution method.

In summary, the constrained power flow problem (20) can be transformed into the following set of nonlinear algebraic equations, which is also a constraint satisfaction problem,

$$\{ \begin{matrix}F ( x ) = 0 \\ H ( x ) = 0 \\ C ( x ) = 0 \\ E ( x ) = 0\end{matrix} . \qquad ( 21 )$$

The constrained AC power flow equations (21) is solved iteratively from an initial guess, or starting point. In one embodiment of the smart power flow solvers, such an initial guess can be set with all θᵢ set to zero radians and all Vᵢ (except at the slack generator bus node and voltage controlled nodes) set to 1.0 per unit, that is, the so-called “flat start.” In another embodiment of the smart power flow solvers, the initial guess can be set as the measured values from the SCADA (supervisory control and data acquisition) system.

TRUST-TECH-based Smart Power Flow Methodology. Under the framework of TRUST-TECH optimization methodology, the constrained power flow problem (21), which is a constraint satisfaction problem, can be solved by solving the following nonlinear unconstrained optimization problem

$${min}_{x} f ( x ) = \frac{1}{2} {F}^{T} ( x ) F ( x ) + \frac{1}{2} {H}^{T} ( x ) H ( x ) + \frac{1}{2} {C}^{T} ( x ) C ( x ) + \frac{1}{2} {E}^{T} ( x ) E ( x ) . \qquad ( 22 )$$

If the constrained power flow problem (21) has a solution, then the optimization problem (22) will have at least one global optimal solution with ƒ(x)=0, since the objective function ƒ(x) is always non-negative.

TRUST-TECH optimization methodology solves the optimization problem (22) using trajectories of a particular class of nonlinear dynamical systems. More specifically, TRUST-TECH based methods accomplish this task by the following steps.

Step i) constructing a dynamical system such that there is a one-to-one correspondence between the set of local optimal solutions to the optimization problem (22) and the set of stable equilibrium points (SEPs) and the set of points in the stable equilibrium manifolds (SEMs) of the dynamical system; in other words, for each local optimal solution to the problem (22), there is a distinct SEP or a point in the SEM of the dynamical system that corresponds to it.

Step ii) then the task of finding all local optimal solutions can be accomplished by finding all SEPs and SEMs of the constructed dynamical system and finding a complete set of local optimal solutions to the problem (22) among the complete set of SEPs and SEMs.

Step iii) finding the global optimal solutions to the problem (22) from the complete set of local optimal solutions.

To this end, we develop a special type of dynamical system, namely the generalized quotient gradient system (QGS) associated with the unconstrained optimization problem (22) for power flow solutions, which has the following expression

\dot{x}=−(∇F(x)·F(x)+∇H(x)·H(x)+∇C(x)·C(x)+∇E_{α}(x)·E_{α}(x)), (23)

where E_{α}(x) is the set of the active Q-limit constraint(s).

Under this transformation, the problem of finding global optimal solutions to the optimization problem (22) is transformed into the problem of finding the stable equilibrium points (SEPs) and stable equilibrium manifolds (SEMs) of the generalized QGS (23) whose corresponding objective function values are zero. It can be shown that the objective function ƒ(x) in (29) is an energy function of the QGS (23).

Theorem 1: (Complete Stability) Every bounded trajectory of the QGS (23) converges to one of the equilibrium points or one of the equilibrium manifolds.

It can be shown that the objective function ƒ(x) in (22) is an energy function of the QGS (23).

Theorem 2: (Solutions and SEPs) A state vector is a solution to the constrained power flow equations (20) if and only if the following two conditions are satisfied: i) the state vector is an SEP or a point in an SEM of the generalized gradient system (23), and ii) the state vector is a global minimum of the optimization problem (22).

The key features of using this new power flow formulation, instead of the conventional one, include the following:

i) This formulation reveals the dynamic and geometric properties of the original power flow problem (21).

ii) The task of finding the solution of the original power flow problem is converted into the task of computing SEMs or SEPs of the QGS system (23). The complete stability of the system allows us to tackle the divergence issue in solving the original power flow problem (21) using conventional methods, such as the Newton's method.

iii) From a control viewpoint, when there is no solution in the original power flow problem, the non-zero QGS energy value at the obtained SEP or SEM can serve as an indicator. This may provide valuable information on how to adjust specific controls to lead the power system into a power balance condition.

iv) Another nice feature of this formulation is that very computationally efficient techniques, such as the pseudo-transient continuation method, can be employed to locate the SEMs or SEPs of the QGS system (23).

v) The disclosed TRUST-TECH formulation is effective and the smart power flow solver is robust for computing the solution even though the initial point can be far away from the power flow solution.

vi) The long-standing problem of how to detect the existence of a power flow solution can be solved by the proposed TRUST-TECH-based method.

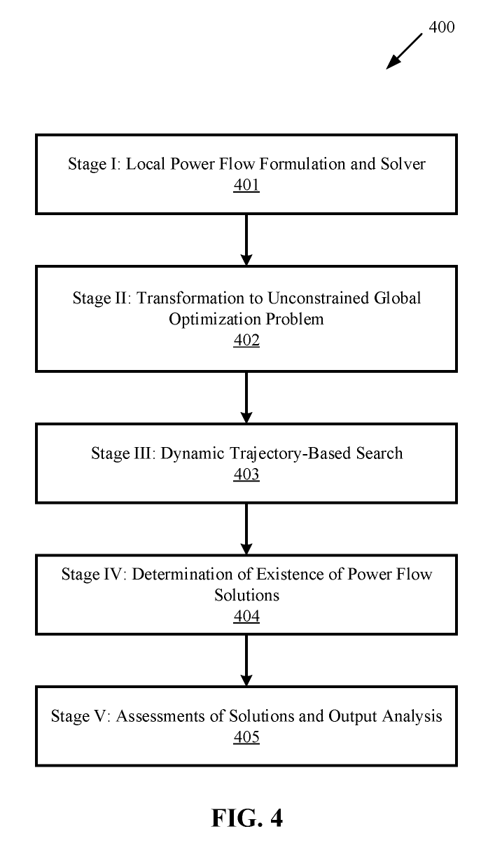

FIG. 4 illustrates a TRUST-TECH-based methodology 400 for power flow solvers according to one embodiment. The methodology 400 includes the following five stages.

Stage I: Nonconventional formulation and the proposed enhanced holomorphic embedding power flow method (block 401).

Stage II: Transformation to the unconstrained optimization problem (22) (block 402).

Stage III: Dynamic search (trajectory-based search) in the associated QGS system (23) to find the global optimal solution to the optimization problem (22) (block 403).

Stage IV: Intelligent determination of the existence of power flow solutions by checking the objective value, which is also the energy value of the QGS system (23), of the global optimal solution to the optimization problem (22) (block 404).

Stage V: Assessments of solutions and output analysis (a power flow solution or suggestion to recover a power flow solution) (block 405).

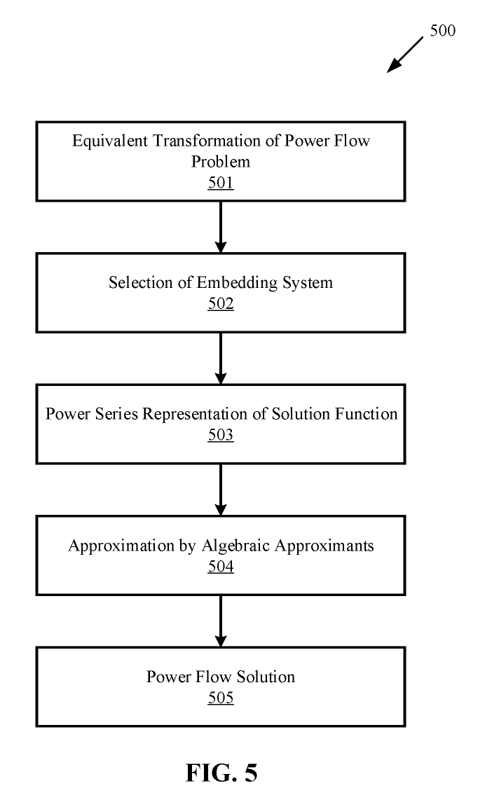

Holomorphic Embedding Power Flow Method. FIG. 5 illustrates a holomorphic embedding power flow (HEPF) method 500 according to one embodiment. The method 500 is a power flow solver using a nonconventional formulation. Consider a power flow problem in rectangular coordinates with PQ buses only, and in the following complex formulation:

Σₖ₌₁ⁿYᵢₖVₖ=lᵢ^{load}+Sᵢ*/Vᵢ*,1≦i≦n, (24)

where the first bus is a slack bus, and Y=(Yᵢₖ)_{n×n} refers to the generalized admittance matrix Y (block 501), containing branch admittance, bus shunt admittances and any constant-impedance injections; lᵢ^{load} is the current injection at bus i; Sᵢ is the power injection at bus i; and Vₖ=eₖ+jfₖ is the complex voltage at bus k; Sᵢ*=μᵢ−jvᵢ is the conjugate of the complex power Sᵢ=μᵢ+jvᵢ; Vₖ*=eₖ−jfₖ is the conjugate of Vₖ; R and C are the spaces of real numbers and complex numbers, respectively, with eₖ, ƒₖ, μi, vᵢεR and the imaginary unit j.

In order to solve Vₖ from (24), the following major steps are carried out: 1) constructing an embedding system for (24) (block 502); 2) representing the solution function of the embedding system by power series near a reference state, and progressively compute the coefficients in power series representation (block 503); 3) calculating an algebraic approximant, using the coefficients in the power series representation (block 504); and 4) obtaining an approximate solution to (24) by the value of algebraic approximant at the target state (block 505).

The first step of HEPF method is to embed the problem (24) into a larger problem, which is also required to be holomorphic; therefore, such a larger problem is called a holomorphic embedding problem. The following requirements need to be met for an embedding problem: 1) The problem at a reference state s₀εC (e.g. s₀=0) has a known solution or the problem can be easily solved; 2) At a target state s₁εC (e.g. s₁=1) the problem coincides with the original problem (24).

One existing embedding problems can be defined as

Eₖ₌₁^{N}YᵢₖVₖ(s)=slᵢ^{load}sSᵢ*/Vᵢ*(s*), (25)

with the choice of the reference state s₀=0, where the parameter sεC, while Vₖ(s) is a complex function in s, and Vₖ*(s)=(Vₖ(s))* and Vₖ*(s*)=(Vₖ(s*))*. The task of solving the problem (25) is to obtain the value Vₖ(S₁), 1≦k≦N. Consequently, the task of solving (24) is converted to compute the function value Vₖ(s) at s=s₁ when an embedding system is constructed. A function ƒ: sεC→ƒ(s)εC is holomorphic (or analytic) at a point s₀εΩ, if the limit

$${f}^{′} ( {s}_{0} ) = {lim}_{h ∈ C , h \to 0} ( f ( {s}_{0} + h ) - f ( {s}_{0} ) ) / h$$

exists, where the displacement hεC with h≠0 and s₀+hεΩ. In addition, ƒ is holomorphic on a domain, Ω, if it is holomorphic at every point in Ω. Moreover, an embedding system is called holomorphic, if the solution functions to the embedding system (e.g. the solution functions Vₖ(S), 1≦k≦N, to problem (25)) are holomorphic in s.

Another existing embedding problem can be defined as

Σₖ₌₁^{N}YᵢₖVₖ(s)=slᵢ^{load}+sSᵢ*/Vᵢ*(s*)

Σₖ₌₁^{N}YᵢₖVᵢ(s*)=slᵢ^{load}*+sSᵢ/Vᵢ(s)′ (26)

to investigate the holomorphic properties of solution functions Vₖ(s), where the second equation is obtained from the first one by the conjugate operations. Yet another existing embedding problem can be defined as

Σₖ₌₁^{N}YᵢₖVₖ(s)−(1−s)Σₖ₌₁^{N}Yᵢₖ=sSᵢ/Vᵢ*(s), (27)

when the equation (24) has zero injection lᵢ^{load} Alternatively, by moving the shunt elements to the right-hand side, another embedding system at PQ buses can be defined as

Σₖ₌₁^{N}Y_{ik,trans}Vₖ(s)=sSᵢ*/Vᵢ*(s*)−sY_{i,shunt}Vᵢ(s), (28)

where, Y_{ik,trans} corresponds to the part of Y that the entries of each row of [Y_{ik,trans}] matrix add up to zero, except the row associated with nodes adjacent to the slack bus. Additionally, Y_{i,shunt} model the shunt admittance components (at bus-i) of the transmission line, off-nominal transformer tap model, shunt capacitors/reactors in the network.

Existing embedding systems usually have the “flat start” values at the reference state of s=0, which limits the flexibility of HEPF. Embodiments of the invention provide a novel embedding system such that the solution value at s=0 can be easily adjusted. The embedding system for the power flow problem (24) at the PQ bus can be formulated as:

$${\sum }_{k = 1}^{N} {Y}_{ik} \{ {V}_{k} ( s ) - ( 1 - s ) {c}_{k} \} = s \{ {I}_{i}^{load} + \frac{{s}_{i}^{*}}{{V}_{i}^{*} ( {s}^{*} )} \} , \qquad ( 29 )$$

where the constant cₖεC\{0} is adjustable, and Vₖ(0)=Cₖ∀k provides a solution for (29) at the reference state s=0. In addition, at the slack bus V₁(s)≡V₁=c₁ for all sεC.

Meanwhile, at a PV bus the active power and the bus voltage (magnitude) usually satisfy the equations that

$$\{ \begin{matrix}{V}_{i} {V}_{i}^{*} = {V}_{i , spec}^{2} , \\ {V}_{i}^{*} {\sum }_{k = 1}^{N} {Y}_{ik} {V}_{k} + {V}_{i} {\sum }_{k = 1}^{N} {Y}_{ik}^{*} {V}_{k}^{*} = 2 {P}_{i}\end{matrix} \qquad ( 30 )$$

where V_{i,spec} is the specified voltage magnitude. Applying the same idea we construct an embedding system at a PV bus that is formulated as:

$$\{ \begin{matrix}{V}_{i} ( s ) {V}_{i}^{*} ( {s}^{*} ) = {c}_{i} {c}_{i}^{*} + s ( {V}_{i , spec}^{2} - {c}_{i} {c}_{i}^{*} ) , \\ \begin{matrix}{V}_{i}^{*} ( {s}^{*} ) {\sum }_{k = 1}^{N} {Y}_{ik} \{ {V}_{k} ( s ) - ( 1 - s ) {c}_{k} \} + \\ {V}_{i} ( s ) {\sum }_{k = 1}^{N} {Y}_{ik}^{*} \{ {V}_{k}^{*} ( {s}^{*} ) - ( 1 - s ) {c}_{k}^{*} \} = 2 {sP}_{i}\end{matrix}\end{matrix} . \qquad ( 31 )$$

Here s₀=0 and s₁=1 are the reference state and the target state, respectively, for both (29) and (31).

To sum up, the new embedding systems are constructed based on the following observations. Firstly, the voltage Vₖ, if known or pre-estimated, has a value cₖεC, then Vₖ(s₀)=cₖ for 1≦k≦n, can be a solution to an embedding system at a reference state. Indeed, such flexibility is provided and shared by (29) and (31) at the reference state s₀=0, but not the existing embedding systems (25)-(28). Secondly, to simulate the mechanism of PV-PQ bus type switching, HEPF needs to start over and compute a new solution if a switching occurs, where the solution obtained before the incumbent switching can be assigned to cₖ's and rerun HEPF for a new solution. This differs from existing methods, which take the flat-start values as the solution for the embedding system (25)-(28) at the reference state s₀=0 after each switching.

For the embedding system (29) and (31) disclosed herein, the following procedure is employed to find the numerical solution to the original power flow equation (24). Take the embedding system (29) as an example, if the solution functions Vₖ(s), 1≦k≦N to (29) are holomorphic in a neighborhood U⊂C of s₀=0, each can be represented by power series as follows,

Vₖ(s)=ε_{q=0}^{∞}a_{kq}s^{q},1/Vₖ(s)=Σq₌₀^{∞}b_{kq}s^{q} (32)

for all sεU. Here the coefficients a_{kq}, b_{kq} can be progressively solved by the value Vₖ(s₀) at s=s₀ and the equations in the system (29) as follows. At s=s₀=0, clearly cₖ provides a nonzero solution to Vₖ(s₀), then

aₖ₀=Vₖ(s₀)=cₖ≠0. (33)

By the smoothness property of Vₖ(s), the value Vₖ(s) #0 for all sεU, in a neighborhood U⊂C of s₀. Consequently,

1=Vₖ(s)·1/Vₖ(s)=Σ_{q=0}^{∞}a_{kq}s^{q}·Σ_{q=0}^{∞}b_{kq}s^{q}=Σ_{q=0}^{∞}Σ_{q′=0}^{∞}a_{kq}′b_{k(q-q′)}s^{q}. (34)

This produces a system of equations for a_{kq}, b_{kq} that

bₖ₀=1/aₖ₀;b_{kq}=−Σ_{q′=1}^{q}a_{kq}′b_{k(q-q′)}/aₖ₀, (35)

for q≧1.

By plugging (32) in (29), it further generates an equation for the coefficients that Σₖ₌₁^{N}Yᵢₖ{Σ_{q=0}^{∞}a_{kq}s^{q}−(1−s)cₖ}−s{lᵢ^{load}+Sᵢ*Σ_{q=0}^{∞}b_{iq}s^{q}}=0 for all i. This equation holds for all sεU, and a comparison of coefficients for s^{q} yields

Σₖ₌₁^{N}Yᵢₖaₖ₁=lᵢ^{load}+Sᵢ*bᵢ₀*−Σₖ₌₁^{N}Yᵢₖcₖ

Σₖ₌₁^{N}Yᵢₖa_{kq}=Sᵢ*b_{i(q-1)}*q≧2 (36)

Coefficients a_{kq}, b_{kq} in (32) can be solved one-by-one; for example:

$${V}_{k} ( {s}_{0} ) {⇔}^{( 33 )} {a}_{k 0} {\to }^{( 34 )} {b}_{k 0} {\to }^{( 35 )} {a}_{k 1} {\to }^{( 34 )} {b}_{k 1} … {a}_{kq} {\to }^{( 34 )} {b}_{k q} {\to }^{( 35 )} {a}_{k ( q + 1 )} {\to }^{( 34 )} {b}_{k ( q + 1 )} … .$$

After some (consecutive) a_{kq} are solved, one can use them to compute the associated Pade approximants for Vₖ(s),

$${[ m / n ]}_{k} ( s ) = \frac{{α}_{k 0} + {α}_{k 1} ( s - {s}_{0} ) + … + {{α}_{km} ( s - {s}_{0} )}^{m}}{{β}_{k 0} + {β}_{k 1} ( s - {s}_{0} ) + … + {{β}_{kn} ( s - {s}_{0} )}^{n}} , \qquad ( 37 )$$

which is a rational function such that

Σ_{q=0}^{∞}a_{kq}=(s−s₀)^{q}−[m/n]ₖ(s)=O((s−s₀)^{m+n+1}), (38)

where, the integers m, n in [m/n]ₖ(s) refer to the degree of the polynomial in the numerator and denominator, respectively. To solve β_{kq}, 0≦q≦n, one can compare the coefficients for the terms (s−s₀)^{m+1}, . . . , (s−s₀)^{m+n} in

Σ_{q=0}ⁿβ_{kq}(s−s₀)^{q}·Σ_{q=0}^{∞}a_{kq}(s−s₀)^{q}=Σ_{q=0}^{m}α_{kq}(s−s₀)^{q}+O((s−s₀)^{m+n+1}), (39)

and derive the following linear system

$$[ \begin{matrix}{a}_{k ( m - n + 1 )} & {a}_{k ( m - n + 2 )} & … & {a}_{km} \\ {a}_{k ( m - n + 2 )} & {a}_{k ( m - n + 3 )} & … & {a}_{k ( m + 1 )} \\ … & … & … & … \\ {a}_{km} & {a}_{k ( m + 1 )} & … & {a}_{k ( m + n + 1 )}\end{matrix} ] [ \begin{matrix}{β}_{kn} \\ {β}_{k ( n - 1 )} \\ … \\ {β}_{k 1}\end{matrix} ] = - [ \begin{matrix}{a}_{k ( m + 1 )} \\ {a}_{k ( m + 2 )} \\ … \\ {a}_{k ( m + n )}\end{matrix} ] , \qquad ( 40 )$$

where βₖ₀=1, and a_{kq}=0 for q<0. Once β_{kq}'s are obtained, the value of a_{kq} can be computed by

α_{kg}=Σ_{q′=0}^{min{n,q}}β_{kq},a_{k(q-q′),}0≦q≦m. (41)

Eventually, an approximation for the solution Vₖ to the original problem (24) is given by [m/n]ₖ(s₁), which is the value of the algebraic approximant at the target state s=s₁.

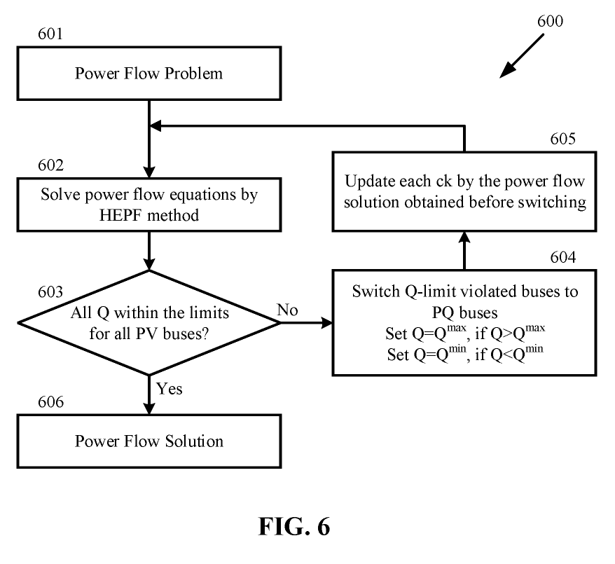

Referring to FIG. 6, the enhanced holomorphic embedding power flow method (block 600), which is enhanced with PV-PQ bus switch handling capabilities, includes the following steps.

Step 1. Convert the conventional power flow problem (14) to the nonconventional formulation (24) in the complex domain (block 601).

Step 2. Solve the power flow problem (24) using the HEPF method (block 602).

Step 3. Check if all generator (PV buses) reactive power (Q) outputs are within the imposed limits. If all Q outputs are within the limits, then go to step 6; otherwise, go to Step 4 (block 603).

Step 4. Switch the Q-limit violated generator (PV) buses to PQ buses by fixing the corresponding Q outputs to the violated lower or upper limit, and making the voltage magnitude a variable (block 604).

Step 5. Update each cₖ in (31) by the power flow solution obtained in Step 2, that is, the power flow solution obtained before PV-PQ switching, and go to Step 2 (block 605).

Step 6. Output the power flow solution and stop the computation (block 606).

Smart Power Flow Solvers. With the above analyses, we now introduce the proposed smart power flow methodology. The proposed smart power flow solver is based on the integration of the proposed TRUST-TECH based power flow method and the enhanced HEPF method, as well as the continuation-based Newton power flow solver. The smart method for power flow analysis is based on the TRUST-TECH methodology. The TRUST-TECH-based power flow method serves to detect the existence of power flow solutions and, if the existence is detected, it computes a point close to a power flow solution. The computed point is then used as an initial guess by a local power flow solver (e.g. the enhanced HEPF method) to compute the precise power flow solution. Hence the power flow divergence issue, which arises in conventional power flow methods when the initial guess is far away from a solution, is overcome by the TRUST-TECH-based power flow method.

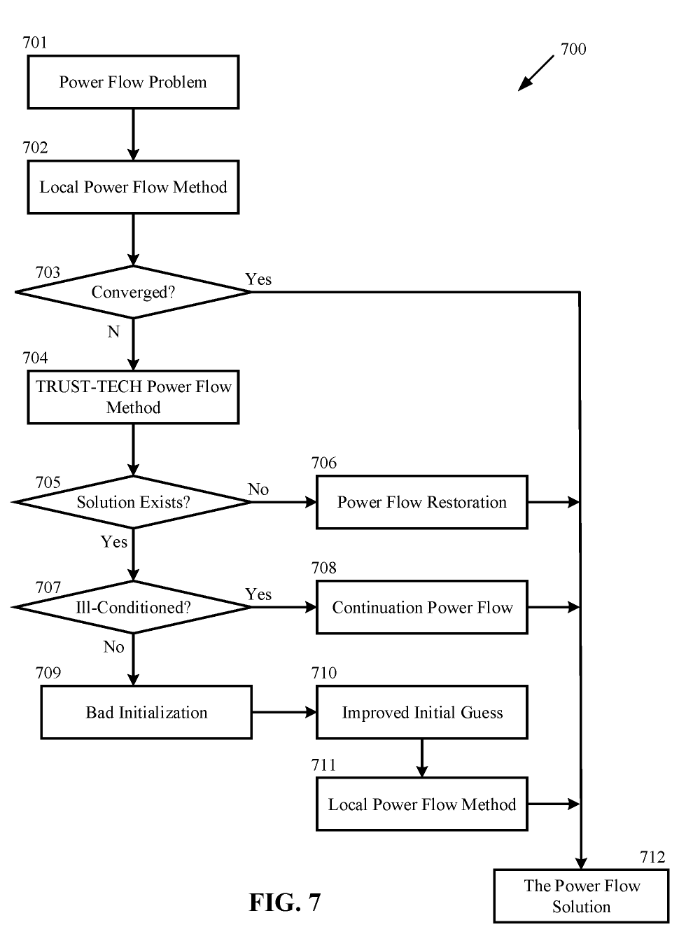

Referring to FIG. 7, the smart power flow solver 700 handles a power flow problem 701 via the following steps.

Step 1: Input power flow study data and formulate the power flow problem (block 701).

Step 2: Apply a local power flow method to the power flow study data (block 702). In one embodiment of the present invention, the local method is the enhanced HEPF method. If it converges, then go to Step 7; if the local method 702 does not converge, go to the next step (block 703), since it might be one of the following reasons that causes the divergence: Reason 1) the power flow solution does not exist; Reason 2) the power flow solution does exist, but the system is ill-conditioned such that the local method cannot compute the solution due to numerical failure; or Reason 3) the power flow solution does exist, but the initial guess is not good enough to lead the local method to the power flow solution.

Divergence of the local method 702 triggers the execution of the TRUST-TECH power flow method 704, while the divergence of the local method 702 will not produce a solution; therefore, there is no output required from 702 by TRUST-TECH 704.

Step 3: Apply the TRUST-TECH power flow method to compute SEPs or SEMs of the associated QGS (23) and compute their QGS energy values, among which the SEPs or SEMs with the lowest energies are identified (block 704).

Step 4: Check if the lowest energies are sufficiently close to zero (block 705). If the energy is not sufficiently close to zero, then a power flow solution does not exist. Operations are performed to restore a power flow solution (block 706) and the process goes to Step 7; otherwise the process goes to the next step (block 707).

Step 5: The energies are sufficiently close to zero, and compute the condition number of the Jacobian matrix of the power flow equations at the SEPs or SEMs with the lowest energies (block 707) to determine whether the power flow problem is ill-conditioned. If the power flow problem is ill-conditioned, then apply a continuation power flow method and compute a power flow solution (708) and the process goes to Step 7; otherwise, the process goes to the next step (block 709).

Step 6: The problem is identified as bad-initialization (block 709). Thus TRUST-TECH power flow method computes an improved initial guess (block 710) and a local power flow method (e.g. the enhanced HEPF method) is applied again, starting from the said improved initial guess, to compute a power flow solution (block 711) and the process goes to Step 7.

Step 7: Assessments of power flow solutions (block 712) and output the analysis.

The proposed smart power flow methodology has the ability to identify the causes for power flow divergence, namely,

i) The smart power flow methodology determines whether a power flow solution exists or not.

ii) If a power flow solution exists, the smart power flow methodology provides a good initial guess to assist a power flow solver, such as the Newton power flow solver or the enhanced HEPF power flow method to compute the power flow solution.

iii) If a power flow solution exists but is ill-conditioned, the smart power flow methodology provides a good initial guess to help a continuation-based Newton power flow solver to compute the power flow solution.

iv) If a power solution does not exist, the smart power flow methodology will provide a closest solution to help restore a power flow solution.

From a computational viewpoint, the development of the proposed smart power flow solvers has broad impacts on many practical applications. In the past, several modifications of the Newton method have been proposed to solve this problem but with limited success. In the area of power flow study, failure of the Newton method to find a power flow solution is a common problem. Overcoming the difficulties of power flow divergence problems will have a far-reaching benefit since the problem is at the heart of several power system studies such as transfer capability calculations, steady-state security assessments, evaluation of power system planned networks, etc.

From an engineering viewpoint, there are also many benefits of smart power flow solvers. For instance, in power system planning

i) The engineering workload can be reduced by elimination of certain tedious and iterative processes of running power flow study.

ii) The existence or non-existence of power flow solutions can be detected.

iii) When there is a power flow solution, a smart power flow solver will compute a power flow solution.

iv) When there is no power flow solution, the smart power flow solver will detect the non-existence of the power flow solution, and suggest a best way to restore a power flow solution.

v) The smart power flow solver offers a means of more efficient use of engineering resources by avoiding the time-consuming process of finding a “non-existing” power flow solution.

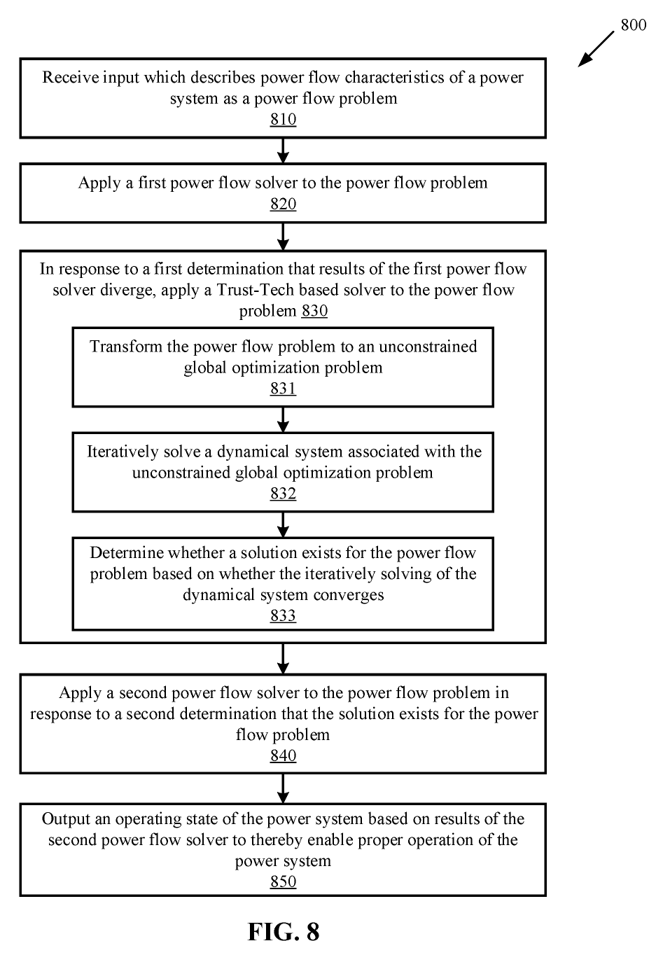

FIG. 8 illustrates a flowchart of a method 800 of a smart power flow solver for analyzing power flow of a power system according to one embodiment. The method 800 comprises: receiving input which describes power flow characteristics of the power system as a power flow problem (step 810); applying a first power flow solver to the power flow problem (step 820); in response to a first determination that results of the first power flow solver diverge, applying a Trust-Tech based solver to the power flow problem (step 830). The step 830 further comprises: transforming the power flow problem to an unconstrained global optimization problem (step 831); iteratively solving a dynamical system associated with the unconstrained global optimization problem (step 832); and determining whether a solution exists for the power flow problem based on whether the iteratively solving of the dynamical system converges (step 833). The method 800 further comprises: applying a second power flow solver to the power flow problem in response to a second determination that the solution exists for the power flow problem (step 840); and outputting an operating state of the power system based on results of the second power flow solver to thereby enable proper operation of the power system (step 850).

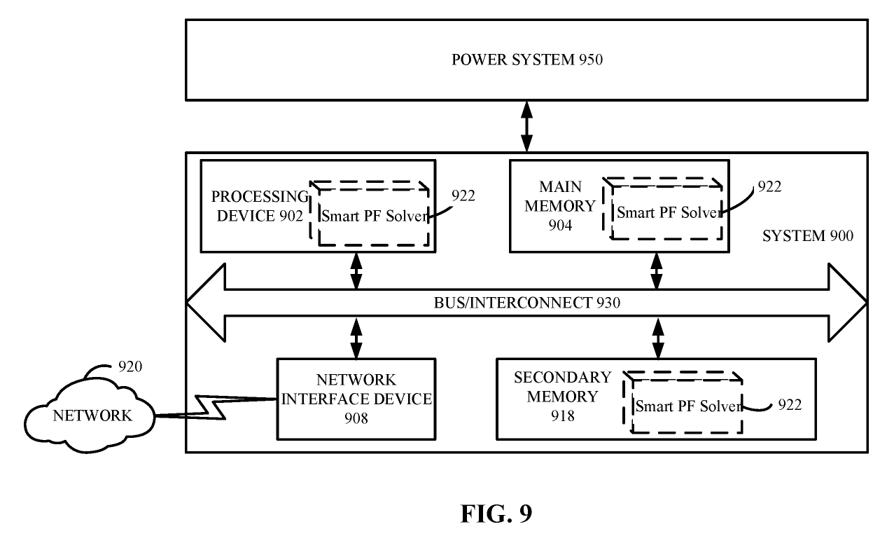

While the method 800 of FIG. 8 shows a particular order of operations performed by certain embodiments of the invention, it should be understood that such order is exemplary (e.g., alternative embodiments may perform the operations in a different order, combine certain operations, overlap certain operations, etc.). One or more parts of an embodiment of the invention may be implemented using different combinations of software, firmware, and/or hardware. In one embodiment, the methods described herein may be performed by a processing system. One example of a processing system is a computer system 900 of FIG. 9.

Referring to FIG. 9, the computer system 900 may be a server computer, or any machine capable of executing a set of instructions (sequential or otherwise) that specify actions to be taken by that machine. While only a single machine is illustrated, the term “machine” shall also be taken to include any collection of machines (e.g., computers) that individually or jointly execute a set (or multiple sets) of instructions to perform any one or more of the methodologies discussed herein. In one embodiment, the computer system 900 may be connected directly or indirectly to a power system 950 to receive data for analyzing power flow of the power system 950.

The computer system 900 includes a processing device 902. The processing device 902 represents one or more general-purpose processors, or one or more special-purpose processors, or any combination of general-purpose and special-purpose processors. In one embodiment, the processing device 902 is adapted to execute the operations of a smart power flow solver, which performs the methods described in connection with FIGS. 4-8 for solving power flow problems.

In one embodiment, the processor device 902 is coupled, via one or more buses or interconnects 930, to one or more memory devices such as: a main memory 904 (e.g., read-only memory (ROM), flash memory, dynamic random access memory (DRAM), a secondary memory 918 (e.g., a magnetic data storage device, an optical magnetic data storage device, etc.), and other forms of computer-readable media, which communicate with each other via a bus or interconnect. The memory devices may also different forms of read-only memories (ROMs), different forms of random access memories (RAMs), static random access memory (SRAM), or any type of media suitable for storing electronic instructions. In one embodiment, the memory devices may store the code and data of a smart power flow (PF) solver 922, which may be stored in one or more of the locations shown as dotted boxes and labeled as smart PF solver 922.

The computer system 900 may further include a network interface device 908. A part or all of the data and code of the smart PF solver 922 may be received over a network 920 via the network interface device 908. Although not shown in FIG. 9, the computer system 900 also may include user input/output devices (e.g., a keyboard, a touch screen, speakers, and/or a display).

In one embodiment, the computer system 900 may store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory devices) and transitory computer-readable transmission media (e.g., electrical, optical, acoustical or other form of propagated signals such as carrier waves, infrared signals).

In one embodiment, a non-transitory computer-readable medium stores thereon instructions that, when executed on one or more processors of the computer system 900, cause the computer system 900 to perform the method 800 of FIG. 8.

Numerical Simulations. The first numerical study is carried out using the enhanced HEPF method to solve a 30-bus power system to examine its claimed capability of dealing with Q-limits and verify its solution with that of conventional Newton's method. This 30-bus system has six generators, therefore, five PV buses. During computation, if the solution contains generators with reactive outputs exceeding their Q limits, that is, the corresponding generators do not have sufficient reactive power capability to support the solution value, then the associated buses are switched from PV to PQ and the reactive generations are fixed to the violated limits, and the power flow again. The modified case has encountered two PV-PQ switches to obtain the final solution, so there are totally three iterations in this process.

The numerical results illustrate that the disclosed HEPF method can correctly handle PV-PQ switch for power flow computation with Q limits. In the meantime, the solution correctness of the HEPF method is also verified by the comparison with the solution by the conventional Newton's power flow method.

The second numerical study is carried out on two power systems with 30 and 2383 buses, respectively, to study the convergence property of the TRUST-TECH formulation to solve the power flow problem. The initial states of the systems are obtained by solving the power flow problem using the disclosed enhanced HEPF method. Moreover, for the convenience of formulation of the system Jacobian and Hessian, the rectangular representation is used in the implementation. More specifically, the optimization variable is constructed as the rectangular representation x=(vₑ, v_{ƒ}), instead of being the polar representation x=(V, θ). In this format, vₑ and v_{ƒ} are the real and imagery parts of the bus voltage, respectively.

Using this state of light load condition as the initial guess, the following two experiments are carried out to compute the system states under different load conditions:

Experiment 1 (a naïve implementation of the continuation power flow):

Step 1: Set x₀ to be the initial power flow solution.

Step 2: Increase both real and reactive loads by 0.05 pu on each load bus.

Step 3: Using x₀ as the initial guess, solve the QGS system (23) to converge (e.g. Δx≦10⁻¹⁰) and get the new state value x₁.

Step 4: If the converged state whose corresponding energy is less than the tolerance (e.g. 10⁻¹⁰), then x₁ is the power flow solution under the new load condition. Then set x₀=x₁ and go to Step 2 for a heavier load condition.

Step 5: The above steps are performed for a number of iterations, with the final loading condition being large enough.

Experiment 2:

Step 1: Set x₀ be the initial power flow solution.

Step 2: Increment the (both real and reactive) load by 0.05 pu on each load bus.

Step 3: Using x₀ as the initial guess, solve the QGS system (23) to converge (e.g. Δx<10⁻¹⁰) and get the new state value

Step 4: If the converged state whose corresponding energy is less than the tolerance (e.g. 10⁻¹⁰), x₁ is the power flow solution under the new load condition. Then go to Step 2 (without updating x₀) for heavier load condition; otherwise, stop the process.

Step 5: The above steps are performed for a number of iterations, with the final loading condition being large enough.

The TRUST-TECH based power flow solver is applied to a 30-bus system and a 2383-bus system using Experiment 1 and Experiment 2. In summary, it is shown from these numerical analysis that the Trust-Tech formulation and the TRUST-TECH based power flow solver exhibit the following properties:

i) The TRUST-TECH formulation is effective.

ii) The solver is very robust to compute the solution even though the initial point can be far away from the power flow solution.

iii) When there exists a power flow solution, the TRUST-TECH solver can provide a good initial condition for other methods such as the Newton method to compute the exact solution.

iv) The solver can detect the existence of a power flow solution (or the existence of a near-by power flow solution).

It has been shown, from the simulation results, that using the initial power flow solution as the initial guess, the TRUST-TECH based formulation for power flow solution can follows the entire (upper-half) P-V curves, which agree well with the solutions obtained using the continuation method (with only slight difference). In other words, the TRUST-TECH based formulation is effective and the TRUST-TECH based solver possesses a very good convergence property.

When there is no feasible power flow solution satisfying all the required conditions, the proposed solver will not diverge. Instead, the solver will converge to an optimal infeasible point, that is, an infeasible point which has a minimal and yet positive value of QGS energy. This QGS energy obtained by the proposed TRUST-TECH based solver gives a degree of infeasibility. The larger the QGS energy, the higher-degree of infeasibility. This is clear from this simulation results that when the loading condition is beyond a “critical” loading condition (i.e. the nose point in the result curve), the converged point found by the proposed method has a non-zero QGS energy value and the farther the loading condition exceeds the nose point; the higher the QGS energy values.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

1. A method for analyzing power flow of a power system comprising:
receiving input which describes power flow characteristics of the power system as a power flow problem;
applying a first power flow solver to the power flow problem;
in response to a first determination that results of the first power flow solver diverge, applying a Trust-Tech based solver to the power flow problem, wherein applying the Trust-Tech based solver further comprises:
transforming the power flow problem to an unconstrained global optimization problem;
iteratively solving a dynamical system associated with the unconstrained global optimization problem; and
determining whether a solution exists for the power flow problem based on whether the iteratively solving of the dynamical system converges;
applying a second power flow solver to the power flow problem in response to a second determination that the solution exists for the power flow problem; and
outputting an operating state of the power system from results of the second power flow solver to thereby enable proper operation of the power system.

2. The method of claim 1, wherein, in response to the second determination that the solution exists for the power flow problem, the method further comprising:
in response to a third determination that the solution is ill-conditioned, applying the second power flow solver which a continuation-based power flow solver to the power flow problem.

3. The method of claim 2, further comprising:
computing a condition number of a Jacobian matrix of power flow equations at stable equilibrium points (SEPs) or stable equilibrium manifolds (SEMs) with lowest energies to determine whether the solution is ill-conditioned.

4. The method of claim 1, wherein, in response to the second determination that the solution exists for the power flow problem, the method further comprising:
in response to a third determination that the solution is not ill-conditioned, applying the second power flow solver which is the same as the first power flow solver to the power flow problem with an improved initial guess.

5. The method of claim 1, wherein the dynamical system is a generalized quotient gradient system (QGS) formulated as:
\dot{x}=(∇F(x)·F(x)+∇H(x)·H(x)+∇C(x)·C(x)+∇Eₐ(x)·Eₐ(x)
where F(x) is a set of algebra equations representing a balance between injected energy and consumed energy in the power system,
H(x) is a set of equality constraints on a slack generator bus,
C(x) is a set of complementary equality constraints, and
E(x) is a set of equality constraints that is transformed from inequality constraints of reactive generation limits, and Eₐ(X) is a subset of active Q-limit constraints in E(x).

6. The method of claim 1, wherein the first power flow solver is a holomorphic embedding power flow (HEPF) solver.

7. The method of claim 6, wherein the HEPF solver uses an embedding system at a PQ bus formulated as:
$${\sum }_{k = 1}^{N} {Y}_{ik} \{ {V}_{k} ( s ) - ( 1 - s ) {c}_{k} \} = s \{ {I}_{i}^{load} + \frac{{s}_{i}^{*}}{{V}_{i}^{*} ( {s}^{*} )} \} .$$
where Y=(Yᵢₖ)_{n×n} is a generalized admittance matrix which contains branch admittance, bus shunt admittances and constant-impedance injections; Iᵢ^{load} is current injection at bus i; Sᵢ and Sᵢ* are power injection and its conjugate at bus i; Vₖ and Vₖ* are complex voltage and its conjugate at bus k; C is a space of complex numbers constant; cₖεC\{0} is adjustable; Vₖ(0)=cₖ∀k provides a solution for the embedding system at a reference state s=0; and at a first bus which is a slack bus, V₁(s)≡V₁=c₁ for all sεC.

8. The method of claim 6, wherein the HEPF solver uses an embedding system at a PV bus formulated as:
$$\{ \begin{matrix}{V}_{i} ( s ) {V}_{i}^{*} ( {s}^{*} ) = {c}_{i} {c}_{i}^{*} + s ( {V}_{i , spec}^{2} - {c}_{i} {c}_{i}^{*} ) , \\ {V}_{i}^{*} ( {s}^{*} ) {\sum }_{k = 1}^{N} {Y}_{ik} \{ {V}_{k} ( s ) - ( 1 - s ) {c}_{k} \} + {V}_{i} ( s ) {\sum }_{k = 1}^{N} {Y}_{ik}^{*} \{ {V}_{k}^{*} ( {s}^{*} ) - ( 1 - s ) {c}_{k}^{*} \} = 2 {sP}_{i}\end{matrix} .$$
where Y=(Yᵢₖ)_{n×n} is a generalized admittance matrix which contains branch admittance, bus shunt admittances and constant-impedance injections; lᵢ^{load} is current injection at bus i; Sᵢ and Sᵢ* are power injection and its conjugate at bus i; Vₖ and Vₖ* are complex voltage and its conjugate at bus k; C is a space of complex numbers constant; cₖεC\{0} is adjustable; s₀=0 and s₁=1 are the reference state and the target state, respectively.

9. The method of claim 6, wherein the HEPF solver is enhanced with PV-PQ bus switch handling capabilities, such that when a switching occurs, a solution obtained before the switching is used for re-running the HEPF solver for a new solution.

10. A system for analyzing power flow of a power system, the system comprising:
one or more processors; and
a memory, the memory containing instructions executable by the one or more processors, the one or more processors operable to:
receive input which describes power flow characteristics of the power system as a power flow problem;
apply a first power flow solver to the power flow problem;
in response to a first determination that results of the first power flow solver diverge, apply a Trust-Tech based solver to the power flow problem, wherein the one or more processors when applying the Trust-Tech based solver are further operative to:
transform the power flow problem to an unconstrained global optimization problem;
iteratively solve a dynamical system associated with the unconstrained global optimization problem; and
determine whether a solution exists for the power flow problem based on whether the iteratively solving of the dynamical system converges;
apply a second power flow solver to the power flow problem in response to a second determination that the solution exists for the power flow problem; and
output an operating state of the power system based on results of the second power flow solver to thereby enable proper operation of the power system.

11. The system of claim 10, wherein, in response to the second determination that the solution exists for the power flow problem, the one or more processors are further operative to:
in response to a third determination that the solution is ill-conditioned, apply the second power flow solver which a continuation-based power flow solver to the power flow problem.

12. The system of claim 11, wherein the one or more processors are further operative to:
compute a condition number of a Jacobian matrix of power flow equations at stable equilibrium points (SEPs) or stable equilibrium manifolds (SEMs) with lowest energies to determine whether the solution is ill-conditioned.

13. The system of claim 10, wherein, in response to the second determination that the solution exists for the power flow problem, the one or more processors are further operative to:
in response to a third determination that the solution is not ill-conditioned, apply the second power flow solver which is the same as the first power flow solver to the power flow problem with an improved initial guess.

14. The system of claim 10, wherein the dynamical system is a generalized quotient gradient system (QGS) formulated as:
\dot{x}=(∇F(x)·F(x)+∇H(x)·H(x)+∇C(x)·C(x)+∇E_{α}(x)·E_{α}(x)
where F(x) is a set of algebra equations representing a balance between injected energy and consumed energy in the power system,
H(x) is a set of equality constraints on a slack generator bus,
C(x) is a set of complementary equality constraints, and
E(x) is a set of equality constraints that is transformed from inequality constraints of reactive generation limits, and E_{α}(x) is a subset of active Q-limit constraints in E(x).

15. The system of claim 10, wherein the first power flow solver is a holomorphic embedding power flow (HEPF) solver.

16. The system of claim 15, wherein the HEPF solver uses an embedding system at a PQ bus formulated as:
$${\sum }_{k = 1}^{N} {Y}_{ik} \{ {V}_{k} ( s ) - ( 1 - s ) {c}_{k} \} = s \{ {I}_{i}^{load} + \frac{{s}_{i}^{*}}{{V}_{i}^{*} ( {s}^{*} )} \} .$$
where Y=(Yᵢₖ)_{n×n} is a generalized admittance matrix which contains branch admittance, bus shunt admittances and constant-impedance injections; lᵢ^{load} is current injection at bus i; Sᵢ and Sᵢ* are power injection and its conjugate at bus i; Vₖ and Vₖ* are complex voltage and its conjugate at bus k; C is a space of complex numbers constant; cₖεC\{0} is adjustable; Vₖ(0)=cₖ∀k provides a solution for the embedding system at a reference state s=0; and at a first bus which is a slack bus, V₁(s)≡V₁=c₁ for all sεC.

17. The system of claim 15, wherein the HEPF solver uses an embedding system at a PV bus formulated as:
$$\{ \begin{matrix}{V}_{i} ( s ) {V}_{i}^{*} ( {s}^{*} ) = {c}_{i} {c}_{i}^{*} + s ( {V}_{i , spec}^{2} - {c}_{i} {c}_{i}^{*} ) , \\ {V}_{i}^{*} ( {s}^{*} ) {\sum }_{k = 1}^{N} {Y}_{ik} \{ {V}_{k} ( s ) - ( 1 - s ) {c}_{k} \} + {V}_{i} ( s ) {\sum }_{k = 1}^{N} {Y}_{ik}^{*} \{ {V}_{k}^{*} ( {s}^{*} ) - ( 1 - s ) {c}_{k}^{*} \} = 2 {sP}_{i}\end{matrix} .$$
where Y=(Yᵢₖ)_{n×n} is a generalized admittance matrix which contains branch admittance, bus shunt admittances and constant-impedance injections; lᵢ^{load} is current injection at bus i; Sᵢ and Sᵢ* are power injection and its conjugate at bus i; Vₖ and Vₖ* are complex voltage and its conjugate at bus k; C is a space of complex numbers constant; cₖεC\{0} is adjustable; s₀=0 and s₁=1 are the reference state and the target state, respectively.

18. The system of claim 15, wherein the HEPF solver is enhanced with PV-PQ bus switch handling capabilities, such that when a switching occurs, a solution obtained before the switching is used for re-running the HEPF solver for a new solution.

19. A non-transitory computer readable storage medium including instructions that, when executed by a computing system, cause the computing system to perform a method for analyzing power flow of a power system, the method comprising:
receiving input which describes power flow characteristics of the power system as a power flow problem;
applying a first power flow solver to the power flow problem;
in response to a first determination that results of the first power flow solver diverge, applying a Trust-Tech based solver to the power flow problem, wherein applying the Trust-Tech based solver further comprises:
transforming the power flow problem to an unconstrained global optimization problem;
iteratively solving a dynamical system associated with the unconstrained global optimization problem; and
determining whether a solution exists for the power flow problem based on whether the iteratively solving of the dynamical system converges;
applying a second power flow solver to the power flow problem in response to a second determination that the solution exists for the power flow problem; and
outputting an operating state of the power system from results of the second power flow solver to thereby enable proper operation of the power system.

20. The non-transitory computer readable storage medium of claim 19, wherein, in response to the second determination that the solution exists for the power flow problem, the method further comprises:
in response to a third determination that the solution is ill-conditioned, applying the second power flow solver which a continuation-based power flow solver to the power flow problem.
